(19) United States
(12) Patent Application Publication
(10) Pub. No.: US 2006/0232915 A1
(43) Pub. Date: Oct. 19, 2006

(54) [HOUSING FOR MONITOR]

(75) Inventors: Miao-Tzu Chou, TAIPEI (TW); Chia-Yen Hsu, TAIPEI (TW); Chia-Shiang Pan, TAIPEI (TW)

Correspondence Address: DATAVAN INTERNATIONAL CORP., P.O. BOX 108-00403, TAIPEI, TW

(73) Assignee: DATAVAN INTERNATIONAL CORP., Jhonghe City, Taipei Hsien. (TW)

(21) Appl. No.: 10/907,863

(22) Filed: Apr. 19, 2005

(51) Int. Cl. G06F 1/16; G02F 1/1333

(52) U.S. Cl. 361/681; 349/58

(57) ABSTRACT

A display panel mounting structure is disclosed to include a casing formed of a front cover shell and a back cover shell, a display module mounted inside the casing, and a touch panel mounted in the casing in front of the display module. The front cover shell has a mounting groove disposed at the front side thereof around the opening thereof for accommodating the touch panel in a flush manner. A rubber packing strip is fastened to the mounting groove of the front cover shell around the periphery of the touch panel to seal the gap and affix the touch panel in place.

### BACKGROUND OF THE INVENTION

1. Field of the Invention

The present invention relates to a display panel mounting structure and more particularly, to such a display panel mounting structure, which reduces the thickness of the assembly, facilitates maintenance work and replacement of the touch panel.

2. Description of the Related Art

Following fast development of high technology, computer and its related products have become requite items in daily life of most people. The application of network communication technology gives people a totally new living, learning, working and entertainment environment. Following the progress of the society and the development of information industry, people can use network communication systems to send real-time information, advertising matter, or e-mails. We can also use the Internet to search desired information, to have a chat with other people at different remote places, play network games, and etc. A monitor is commonly used as a communication interface between a computer and its user. From early CRT (cathode ray tube) monitors to current LCD monitors, it is the market trend to provide monitors having light and thin characteristics. Nowadays, touch screen monitors have been well developed for input with the finger or a touch pen instead of a keyboard or mouse. A touch screen monitor is commonly used in different industries and information inquiry systems, making a computer system more humanized. FIG. 6 is a sectional view of a part of a regular touch screen monitor. According to this design, the touch screen monitor comprises a casing A, a display module B mounted inside the casing A, a touch panel C mounted inside the casing A in front of the display module B, a front cover A1 fixedly fastened to the casing A in front of the touch panel C, and a rubber packing strip C1 mounted in between the front cover A1 and the touch panel C around the border area to seal the gap against outside water or moisture. During installation, the display module B and the touch panel C are arranged in a stack and then mounted inside the casing A, and then the front cover A1 is affixed to the casing A. Because the display module B, the touch panel C, and the front cover A1 are attached to one another in a stack, the touch screen monitor has a certain thickness, not in conformity with the market trend of light and thin product features. Further, if the touch panel C is damaged after a long use and a replacement is needed, the maintenance engineer can access to the touch panel C only after the front cover A1 has been detached. This maintenance work is complicated. In case a small screw or component part is missed during mounting or dismounting procedure, the installation may fail.

Therefore, it is desirable to provide a display panel mounting structure that eliminates the aforesaid drawbacks.

### SUMMARY OF THE INVENTION

The present invention has been accomplished under the circumstances in view. It is therefore the main object of the present invention to provide a display panel mounting structure, which greatly reduces the thickness of the assembly. It is another object of the present invention to provide a display panel mounting structure, which facilitates maintenance work and replacement of the touch panel.

To achieve these and other objects of the present invention, the display panel mounting structure comprises a casing holding a display module and a touch panel, wherein the casing has a mounting groove formed in the front cover shell thereof around the opening of the front cover shell; the touch panel is mounted in the mounting groove over the opening of the front cover shell of the casing and kept in flush with the front cover shell. Further, a rubber packing strip is adhered to the mounting groove of the front cover shell around the periphery of the touch panel to seal the gap. The touch panel can be removed from the front cover shell of the casing for a replacement when detached the rubber packing strip.

### BRIEF DESCRIPTION OF THE DRAWINGS

FIG. 1 is an elevational view of the preferred embodiment of the present invention.

FIG. 2 is an exploded view of the preferred embodiment of the present invention.

FIG. 3 is a sectional side view of the preferred embodiment of the present invention before installation.

FIG. 4 is a sectional side view of the preferred embodiment of the present invention after installation of the display module in the back cover shell and the touch panel in the front cover shell before connection of the front cover shell to the back cover shell.

FIG. 5 is a sectional side view showing the preferred embodiment of the present invention assembled.

FIG. 6 is a sectional view of a part of a touch screen monitor according to the prior art.

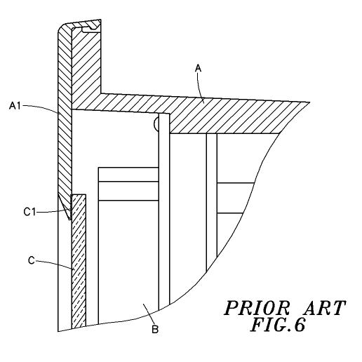

### DETAILED DESCRIPTION OF THE PREFERRED EMBODIMENT

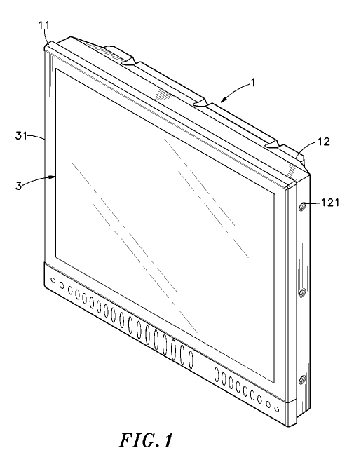

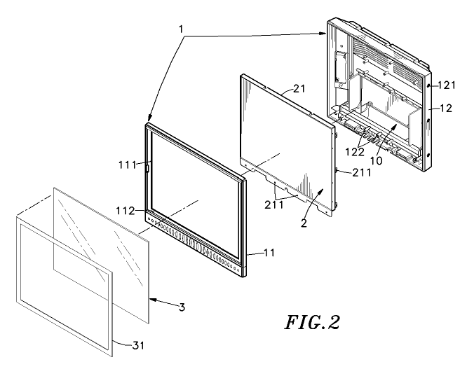

Referring to FIGS. 1 and 2, a display panel mounting structure in accordance with the present invention is shown comprising a casing 1, a display module 2, and a touch panel 3.

The casing 1 is a hollow device comprised of a front cover shell 11 and a back cover shell 12. The front cover shell 11 and the back cover shell 12 define an accommodating chamber 10 adapted to accommodate the display module 2. The front cover shell 11 has an opening 111 in communication with the accommodating chamber 10, a mounting groove 112 extending around the opening 111 at one side, namely, the front side. The back cover shell 12 has a plurality of through holes 121 symmetrically disposed at two opposite lateral sides, and a plurality of locating portions 122 disposed at the bottom side.

The display module 2 can be a liquid crystal display module or plasma display module, comprising a frame 21 fitted into the accommodating chamber 10 of the casing 1. The frame 21 has a plurality of mounting holes 211 disposed at two opposite lateral sides and the bottom side corresponding to the through holes 121 and locating portions 122 of the back cover shell 12 of the casing 1.

The touch panel 3 is provided at the front side of the display module 2 and mounted in the mounting groove 112 within the front cover shell 11 of the casing 1. Further, a rubber packing strip 31 is fastened to the mounting groove 112 around the periphery of the touch panel 3 to seal the gap between the touch panel 3 and the mounting groove 112 and to secure the touch panel 3 firmly to the front cover shell 11.

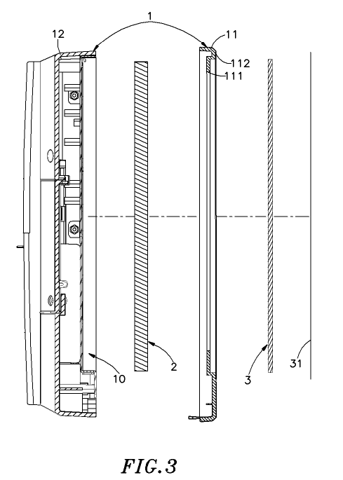

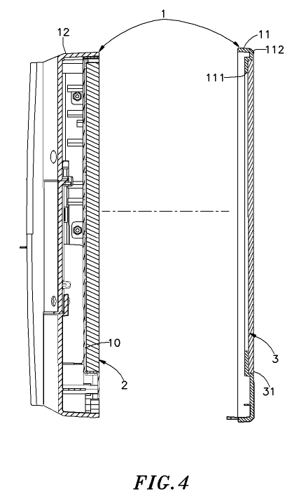

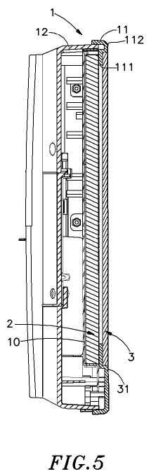

Referring to FIGS. 3˜5 and FIGS. 1 and 2 again, during installation, the display module 2 with the frame 21 is inserted into the accommodating chamber 10 of the casing 1, and then the mounting holes 211 of the frame 21 are respectively fastened to the through holes 121 and locating portions 122 of the back cover shell 12 of the casing 1, and then the touch panel 3 is put in the mounting groove 112 within the front cover shell 11 of the casing 1, and then the rubber packing strip 31 is adhered to the mounting groove 112 around the periphery of the touch panel 3 to seal the gap between the touch panel 3 and the front cover shell 11 and to secure the touch panel 3 firmly to the front cover shell 11 (as shown in FIG. 4), and then the mounting groove 112 is affixed to the back cover shell 12 to finish the installation (as shown in FIG. 5). When wishing to replace the touch panel 3, the replacement work can easily be performed within a short time simply by detaching the rubber packing strip 31 from the front cover shell 11. Further, the depth and size of the mounting groove 112 of the front cover shell 11 is determined subject to the touch panel 3 used. After installation of the touch panel 3 in the mounting groove 112, the touch panel 3 is kept in flush with the front cover shell 11. If the touch panel 3 is not needed, a glass or protective lens of equal size can be installed in the mounting groove 112 of the front cover shell 11 to substitute for the touch panel 3.

As indicated above, the touch panel 3 is directly mounted in the mounting groove 112 of the front cover shell 11 and kept in flush with the front cover shell 11. Therefore, the installation of the touch panel 3 is simple and does not increase the thickness of the display panel. During a repair or replacement work, the touch panel 3 can easily be removed from the display panel simply by detaching the rubber packing strip 31 from the front cover shell 11 of the casing 1.

A prototype of display panel mounting structure has been constructed with the features of FIGS. 1˜5. The display panel mounting structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A display panel mounting structure comprising:
a casing, said casing comprising a back cover shell, a front cover shell covering said back cover shell, and an accommodating chamber defined in between said front cover shell and said back cover shell, said front cover shell having an opening in communication with said accommodating chamber;
a display module mounted in said accommodating chamber inside said casing; and
a touch panel disposed in front of said display module;
wherein said front cover shell comprises a mounting groove disposed at a front side thereof and extending around the opening of said front cover shell; said touch panel is mounted in said mounting groove over said opening and kept in flush with said front cover shell.

2. The display panel mounting structure as claimed in claim 1, wherein said back cover shell comprises a plurality of through holes symmetrically disposed at two opposite lateral sides thereof and a plurality of locating portions disposed at a bottom side thereof; said display module comprises a frame fastened to the periphery thereof, said frame comprising a plurality of mounting holes respectively fastened to the through holes and locating portions of said back cover shell.

3. The display panel mounting structure as claimed in claim 1, further comprising a rubber packing strip sealed to said mounting groove of said front cover shell around the periphery of said touch panel.

4. The display panel mounting structure as claimed in claim 1, wherein said display module is a liquid crystal display module.

5. The display panel mounting structure as claimed in claim 1, wherein said display module is a plasma display module.
